(19) United States
(12) Patent Application Publication
(10) Pub. No.: US 2018/0250840 A1
(43) Pub. Date: Sep. 6, 2018

(54) ILLUMINATED HAIRCUTTING SHEARS

(71) Applicant: JOHN C. LYDICK, PANAMA CITY, FL (US)

(72) Inventor: JOHN C. LYDICK, PANAMA CITY, FL (US)

(21) Appl. No.: 15/902,960

(22) Filed: Feb. 22, 2018

Related U.S. Application Data
(60) Provisional application No. 62/467,777, filed on Mar. 6, 2017.

(51) Int. Cl. B26B 13/24; G01B 21/22; G01C 9/06; F21L 4/08; H05B 33/08; F21V 33/00; G08B 5/36

(52) U.S. Cl. CPC B26B 13/24; G01B 21/22; G01C 9/06; F21L 4/08; F21Y 2115/10; F21V 33/0084; G08B 5/36; G01C 2009/066; H05B 33/0872

(57) ABSTRACT

The illuminated haircutting shears includes a pair of cutting blades, a light source, a light strip, and an energy source in communication with the light source. A microcontroller and an accelerometer positioned in communicating relation with the microcontroller may also be provided. In use, the accelerometer generates acceleration signals which are communicated to the light strip via the microcontroller. In response, a respective color of light illuminates to indicate the position of the shears, e.g., 0° (e.g. horizontal), 45° (e.g. diagonal), or 90° (e.g. vertical).

### CROSS-REFERENCE TO RELATED APPLICATION

This application claims the benefit of U.S. Provisional Patent Application Ser. No. 62/467,777, filed Mar. 6, 2017, which is herein incorporated by reference in its entirety.

### BACKGROUND

### 1. Field

The present disclosure relates to a cutting device, and particularly to illuminated haircutting shears configured to indicate an angle or range of angles of the shears with respect to a horizontal surface, such as the ground, during use of the shears.

### 2. Description of the Related Art

A hair stylist is often required to hold haircutting shears at many different angles in order to achieve a desired haircut. As such, accuracy and precision play an important role in haircutting. In the past, hairstylists have generally relied only on visual inspection of the hair to avoid an uneven haircut. Accordingly, despite the diligence of many hairstylists, uneven haircuts are fairly common. Although levels and the like are known in the art, particularly in the building arts, the use of such levels to accurately position haircutting sheers would be awkward and wieldy.

Thus, haircutting shears solving the aforementioned problems is desired.

### SUMMARY

The pair of illuminated haircutting shears includes at least one light source for visually indicating, through color, an angle or angular range of the shears with respect to a horizontal plane, such as the ground. The pair of illuminated haircutting shears includes first and second opposed blades pivotally secured to one another, such as, respectively, a stationary blade and a moving blade, as in a conventional pair of shears. At least one light source is mounted on the stationary blade for selectively generating light in a plurality of different colors. The at least one light source may be, for example, a variable color light emitting diode. A light strip is mounted on the stationary blade for selectively displaying light in a plurality of different colors.

An angle sensor, such as an accelerometer, is further mounted in or on the stationary blade, along with a controller, which is in electrical communication with the angle sensor and the at least one light source. The controller selectively generates a signal to actuate the at least one light source for producing the light in a selected one of the plurality of different colors, where the selected one of the plurality of different colors corresponds to an angle measured by the angle sensor.

These and other features of the present disclosure will become readily apparent upon further review of the following specification and drawings.

### BRIEF DESCRIPTION OF THE DRAWINGS

FIG. 1 is an environmental view of illuminated haircutting shears.

FIG. 2 is a top plan view of the illuminated haircutting shears.

FIG. 3 is a diagram illustrating the relationship between certain components of the illuminated haircutting shears.

FIG. 4 illustrates an illuminated haircutting shears kit for modifying or retrofitting conventional shears.

Similar reference characters denote corresponding features consistently throughout the attached drawings.

### DETAILED DESCRIPTION OF THE PREFERRED EMBODIMENTS

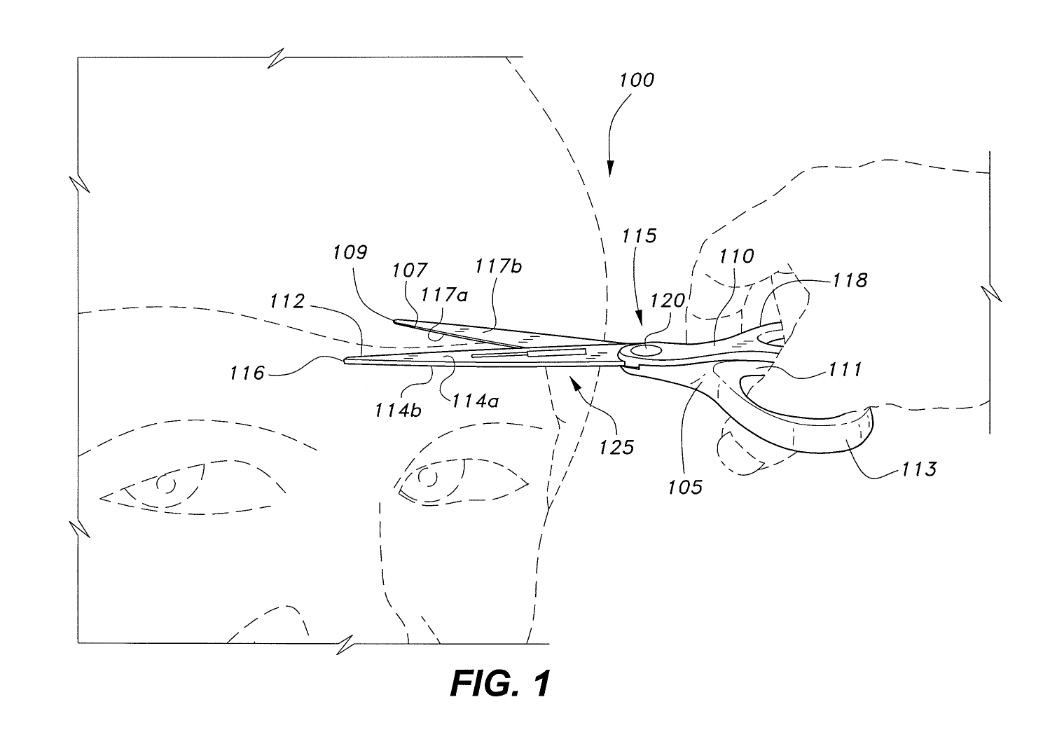

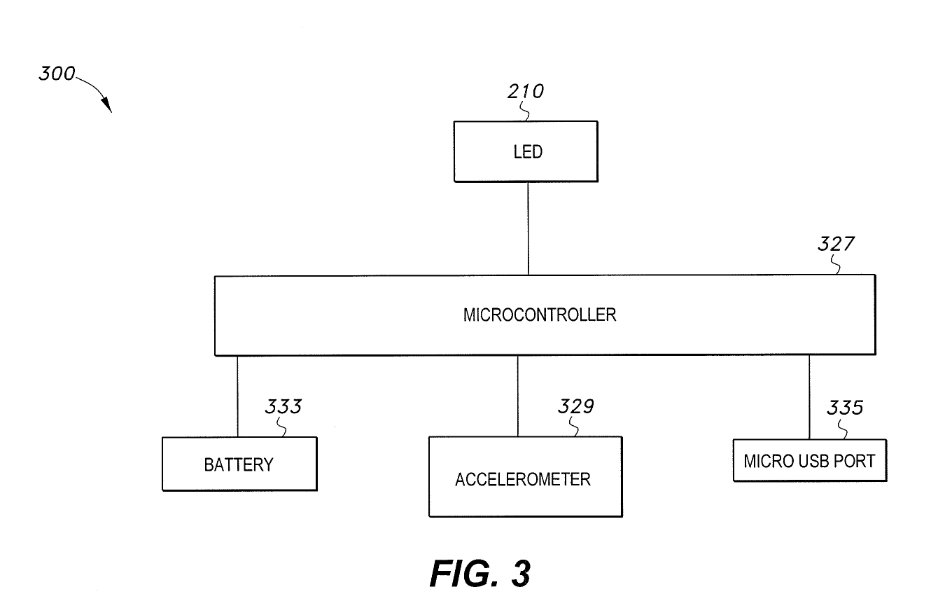

Referring now to FIGS. 1 through 3, there is shown a pair of illuminated haircutting shears 100. As shown, illuminated haircutting shears 100 include two opposed movable blades, herein referred to as moveable or thumb blade 105 and stationary blade 110 (although also moveable, blade 110 is held stationary during cutting whether for right or left handed shears). When cutting hair, a hair stylist will typically hold one blade of the cutting shears stationary (i.e., the stationary blade 110) and will pivot the other blade (i.e., the movable blade 105) to cut the hair. The cutting blades 105, 110 are moveable relative to one another, such as about a pivot point 115. It should be understood that the moveable cutting blade 105 can be pivotally connected to the stationary cutting blade 110 with any suitable fastener 120, such as a screw, bolt or the like.

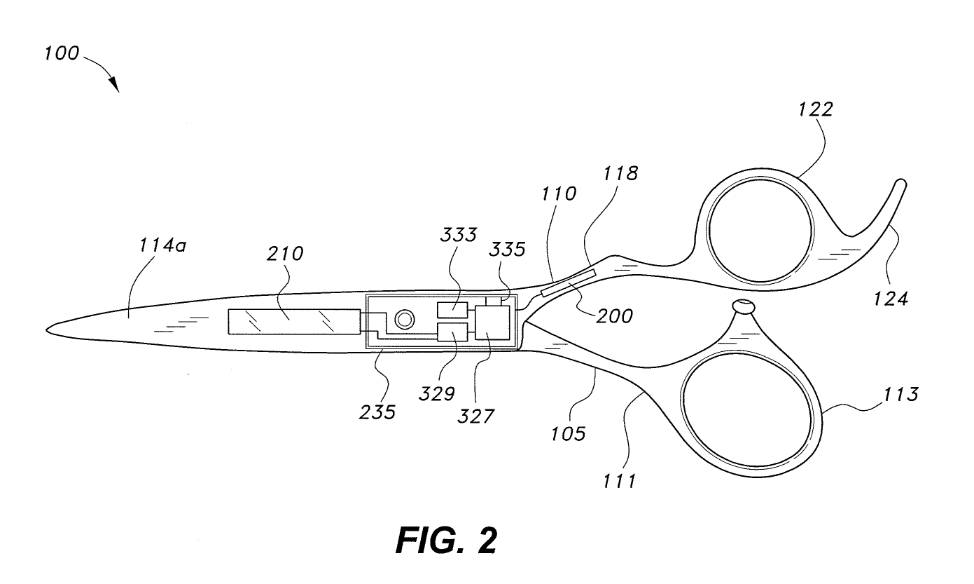

As shown in FIG. 2, the illuminated haircutting shears 100 include a light source 200 in the handle 122 (corresponding to the stationary cutting blade 110), a light strip 210 in communication with the light source 200, and an energy source, such as a conventional battery 333, in communication with the light source 200. The light strip 210 can be a fiber optic material capable of transmitting light from the light source 200 along the stationary blade 110. The battery 333 can be a rechargeable battery for powering the light source 200 and can be disposed in an inner surface of the stationary blade 110. The light source 200 can be a light emitting diode (LED) or the like, such as a primary color LED, a multiple-color light source or the like. Preferably, the light source 200 is capable of generating a variety of different colors, dependent upon a particular voltage delivered thereto. The shears 100 can include a universal serial bus (USB) port, such as micro USB port 335, configured for receiving a USB charging cable (not shown) so as to charge the battery 333. Alternatively, the battery 333 can be charged wirelessly, such as through inductive charging.

The cutting blades of the shears 100 can include any suitable type of conventional blades known in the art. For example, the stationary cutting blade 110 can include a first elongate cutting edge 112 extending between opposing first and second ends 116, 118 of the cutting stationary cutting blade 110, and the moveable cutting blade 105 can include a second elongate cutting edge 107 extending between opposing first and second ends 109, 111 of the moveable cutting blade 105. The stationary cutting blade 110 can include an outer surface 114a and an opposing inner surface 114b, as well as a bow handle 122 having a finger rest 124 attached thereto. It is to be understood that the stationary cutting blade 110 and the bow handle 122 can be one piece. The moveable cutting blade 105 includes an outer surface 117a and an opposing inner surface 117b, as well as a ring handle 113. The moveable cutting blade 105 and the ring handle 113 can be one piece. As noted above, the cutting blades 105, 110 are pivoted relative to each other at the pivot point 115. The shears 100 can be formed from any suitable material, such as metal or plastic, and have any suitable length.

Additionally, the illuminated haircutting shears 100 may also include a microcontroller 327 and, optionally, an accelerometer 329 communicating with the microcontroller 327 (shown integrated into a housing 125 in the stationary cutting blade 110 in FIG. 1). The light source 200 can be positioned in communicating relation with the microcontroller 327.

Movement of the blades can be detected in real time by the accelerometer 329. The accelerometer 329 generates signals which are communicated to the light source 200 via the microcontroller 327. In response, a respective one of a plurality of colors illuminates to indicate the angle of the shears. For example, a red light may illuminate when the angle of the stationary cutting blade 110 relative to the earth's gravitational field is 0° (e.g. horizontal), a green light may illuminate when the angle of the stationary cutting blade 110 relative to the earth's gravitational field is 45° (e.g. diagonal), and a blue light may illuminate when the angle of the stationary cutting blade 110 relative to the earth's gravitational field is 90° (e.g. vertical). In other words, different positions of the stationary blade 110 relative to the earth's gravitational field will be indicated by a different color visible in the light strip 210. The accelerometer 329 can function in reverse orientation as well, e.g., 0°, −45°, −90°.

It should be noted that the shears 100 may be configured without the accelerometer 329. Such shears 100 can still include the LED light 200 positioned in communicating relation with the battery 333, such that the LED light 200 emits a single primary color, such as red, green, or blue, or a plain white light, to serve as a visual reference for the hairstylist.

The microcontroller 327 can be any suitable type of computer controller configured for sending an actuator signal to the LED light 200 so as to illuminate the light strip 210 in its respective color (e.g., red, blue or green). Further, the accelerometer 331 can be any suitable type of accelerometer configured for gathering data and determining the position of the stationary cutting blade 110 of the shears 100 relative to the earth's gravitational field. It should be understood that accelerometer 331 may be replaced by any suitable type of angle sensor, as are well known in the art.

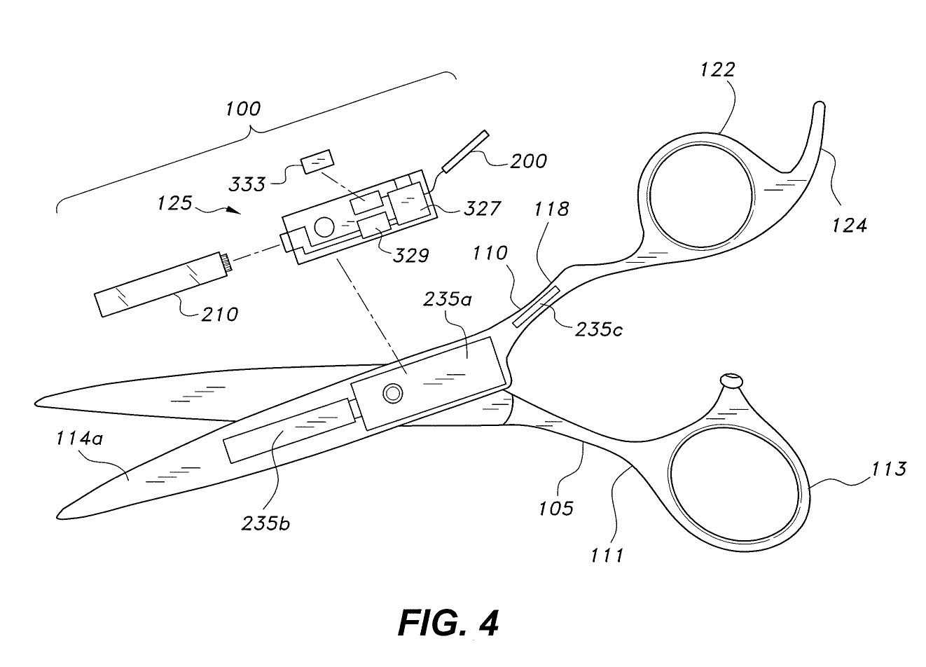

As shown in FIG. 4, the battery 333, the light source 200, the light strip 210, the microcontroller 327, and optionally, the accelerometer 331, may be provided as components within a kit. The components of the kit can be adapted for attachment to a conventional or existing pair of shears S that have a stationary cutting blade and a moveable cutting blade in any suitable manner. For example, a milling machine or other suitable machine can be used to form appropriate grooves 235a-235c in the stationary cutting blade. Grooves 235a and 235b in the stationary cutting blade can receive the microcontroller 327 and the light strip 210, respectively. The accelerometer 329, if desired, can also be disposed in groove 235a. The light source 200 can be disposed in groove 235c. As such, the microcontroller 327, the battery 333, and the accelerometer 329 and the light strip 200 can be embedded within the stationary cutting blade, or other appropriate position.

As noted above, the pair of illuminated haircutting shears 100 includes at least one light source for visually indicating, through color, an angle or angular range of the shears with respect to a horizontal plane or surface, such as the ground. It should be further understood that although light source 200 has been described as being a variable color light emitting diode (LED) for selectively producing red light, blue light or green light, the light source 200 may be any suitable type of variable color light source under the control of controller 327.

Further, it should be understood that controller 327 may be any suitable type of controller, microcontroller, processor, programmable logic controller or the like. It should be further understood that the first and second opposed blades 110, 105 are shown in FIGS. 1 and 2 for exemplary purposes only, and that the pair of illuminated haircutting shears 100 may include any suitable type of blades, such as are commonly associated with shears, scissors or the like. It should be further understood that although accelerometer 331 is described above as being in communication with controller 327 for generating angle-dependent actuation signals, any suitable type of electronic or digital angle sensor may be used.

Thus, overall, it should be understood that any suitable type of controller 327 may be used for selectively generating a signal to actuate the at least one light source for producing the light in a selected one of the plurality of different colors, where the selected one of the plurality of different colors corresponds to an angular range measured by the angle sensor. As an example, if the angle sensor 331, which may be an accelerometer, for example, detects an angle of approximately 0° with respect to the ground (or within an angular range having a selected angular and/or error tolerance), then controller 327 generates a signal such that first light source will illuminate and, for example, a red light will be visible in the light strip 210. In this example, if the angle sensor 331, detects a diagonal angle, such as approximately 45° with respect to the ground ((or within an angular range having a selected angular and/or error tolerance), then controller 327 generates a signal such that first light source 200 will illuminate and, for example, a green light will be displayed in the light strip 210. If the angle sensor 331, in this example, detects an angle of approximately 90° with respect to the ground ((or within an angular range having a selected angular and/or error tolerance), then controller 327 generates a signal such that first light source 200 will illuminate and, for example, a blue light will be displayed in the light strip 210. It should be understood that the angle sensor 329 can function in reverse orientation as well, e.g., 0°, −45° and −90°, respectively, with respect to the horizontal.

It is to be understood that the illuminated haircutting shears is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A pair of illuminated haircutting shears, comprising:
first and second opposed blades pivotally secured to one another;
at least one light source mounted on the first blade;
a variable light strip in communication with the at least one light source; and
a controller mounted on the first blade, the controller being in electrical communication with the angle sensor and the at least one light source, wherein the controller selectively generates a signal to actuate the at least one light source for producing light in a selected one of a plurality of different colors,.

2. The pair of illuminated haircutting shears as recited in claim 1, wherein the at least one light source comprises a variable color light emitting diode.

3. The pair of illuminated haircutting shears as recited in claim 1, further comprising an angle sensor, the selected one of the plurality of different colors corresponding to an angle measured by the angle sensor.

4. The pair of illuminated haircutting shears as recited in claim 3, wherein the angle sensor comprises an accelerometer.

5. The pair of illuminated haircutting shears as recited in claim 1, wherein each of the first and second opposed blades comprises a cutting portion and a handle portion.

6. The pair of illuminated haircutting shears as recited in claim 1, further comprising a battery attached to the first blade, the battery being in electrical communication with the controller and the at least one light source.

7. The pair of illuminated haircutting shears as recited in claim 6, further comprising a charging port mounted on the first blade, the charging port being in electrical communication with the battery for selective recharging thereof.

8. A pair of illuminated haircutting shears, comprising:
stationary and moveable opposed blades pivotally secured to one another;
a light source attached to the stationary blade, wherein the light source selectively generates light in a plurality of different colors;
an angle sensor mounted on the stationary blade; and
a controller mounted on the stationary blade, the controller being in electrical communication with the angle sensor and the light source, wherein
the controller selectively generates signals to respectively actuate the light source for producing the light in a selected one of the plurality of different colors, the selected one of the plurality of different colors corresponding to an angle measured by the angle sensor.

9. The pair of illuminated haircutting shears as recited in claim 8, wherein the light source comprises a variable color light emitting diode.

10. The pair of illuminated haircutting shears as recited in claim 8, wherein the angle sensor comprises an accelerometer.

11. The pair of illuminated haircutting shears as recited in claim 8, wherein each of the first and second opposed blades comprises a cutting portion and a handle portion.

12. The pair of illuminated haircutting shears as recited in claim 8, further comprising a battery mounted on the stationary blade, the battery being in electrical communication with the controller and the at least one light source.

13. The pair of illuminated haircutting shears as recited in claim 8, further comprising a charging port mounted on the stationary blade, the charging port being in electrical communication with the battery for selective recharging thereof.

14. A pair of illuminated haircutting shears, comprising:
first and second opposed blades pivotally secured to one another;
a variable color light emitting diode mounted in the first blade for selectively generating light in a plurality of different colors;
an accelerometer mounted in the first blade for measuring an angle of the first blade with respect to a horizontal plane; and
a controller mounted in the first blade, the controller being in electrical communication with the accelerometer and the variable color light emitting diode, wherein the controller selectively generates a signal to actuate the variable color light emitting diode for producing the light in a selected one of the plurality of different colors, the selected one of the plurality of different colors corresponding to an angle measured by the accelerometer.

15. The pair of illuminated haircutting shears as recited in claim 14, further comprising a light strip attached in the first blade.
